(19) United States
(12) Patent Application Publication
(10) Pub. No.: US 2017/0182601 A1
(43) Pub. Date: Jun. 29, 2017

(54) Flux-Coated Ball and Method of Manufacturing the Same

(71) Applicant: Senju Metal Industry Co., Ltd., Tokyo (JP)

(72) Inventors: Hiroyoshi Kawasaki, Tochigi (JP); Takashi Hagiwara, Tochigi (JP); Yuji Kawamata, Tochigi (JP)

(21) Appl. No.: 15/389,550

(22) Filed: Dec. 23, 2016

(30) Foreign Application Priority Data
Dec. 28, 2015 (JP) 2015-256938

(51) Int. Cl. B23K 35/02; C23C 26/00; B23K 35/26; H01B 1/02; B23K 35/36

(52) U.S. Cl. CPC B23K 35/0244; H01B 1/02; B23K 35/3612; B23K 35/262; B23K 35/3613; C23C 26/00

(57) ABSTRACT

Provided herein is a flux-coated ball having a ball-like joining material and a flux layer that covers a surface of the joining material. The flux layer is formed from high volatile flux solvent including ethyl acetate, acetone or methyl ethyl ketone. Thickness of the flux layer ranges from 2.5 μm to 50 μm. A diameter of the flux-coated ball is 600 μm or less. A sphericity of the flux-coated ball is 0.9 or more.

### CROSS-REFERENCE TO RELATED APPLICATION

This application claims priority to Japanese Patent Application No. 2015-256938 filed Dec. 28, 2015, the disclosure of which is hereby incorporated in its entirety by reference.

### TECHNICAL FIELD

The present invention relates to a flux-coated ball and a method of manufacturing the same.

### BACKGROUND ART

Recently, along with development of compact information equipment, electronic components to be mounted have been rapidly downsized. A ball grid alley (hereinafter referred to as “BGA”) having electrodes at its rear surface has been applied, in place of wire bonding, to such electronic components in order to cope with a narrowed connection terminal and a reduced mounting area because of the downsizing requirement.

As the electronic component to which BGA is applied, for example, a semiconductor package is exemplified. In the semiconductor package, a semiconductor chip having electrodes joins a conductive land of a printed circuit board through a solder bump (a solder ball) and any resin seals them.

Moreover, any development of the flux-coated ball in which flux is previously coated on a surface of a solder ball has been recently advanced. Using such a flux-coated ball allows manufacturing steps of the semiconductor package to be simplified because a step of coating the flux on the terminal of the printed circuit board is omitted.

For example, Japanese Patent ApplicationpublicationNo. 2007-115858 discloses a micro ball having a diameter of 600 μm or less in which a solder ball and a flux layer that coats the solder ball are provided.

### SUMMARY OF THE INVENTION

The flux-coated ball in which the flux coats the solder ball, however, may degrade its sphericity because many large crystal grains occur thereon due to crystallization of the flux component. Specifically, the micro ball having a small diameter, disclosed in Japanese Patent Application publication No. 2007-115858, may degrade its sphericity considerably.

Accordingly, the present addresses these issues and has objects to provide a flux-coated ball which has high sphericity even when it has a small diameter and a method of manufacturing the flux-coated ball.

The inventors have paid attention to a fact that any crystals in the flux layer can grow only in a solvent but when the solvent has once evaporated, any crystal growth cannot be done. They also have found out that the flux solvent changes over to a high volatile solvent so that the solvent rapidly evaporates and any crystal growth is prevented, which enables the crystal grains to be made smaller in the flux layer.

To achieve at least one of the above objects, according to an aspect of the present invention, there is provided with a flux-coated ball containing a ball-like joining material and a flux layer that covers a surface of the joining material, wherein the flux layer includes a solvent which is a single or mixed solvent selected from the group of ethyl acetate, acetone and methyl ethyl ketone, and wherein thickness of the flux layer is within a range between 2.5 μm or more and 50 μm or less and a diameter of the flux-coated ball is 600 μm or less, and sphericity of the flux-coated ball is 0.9 or more.

According to embodiments of the present invention, it is desired to provide a flux-coated ball wherein the joining material contains a metal, a metal compound, an alloy, a metal oxide or a mixed metal oxide.

It is also desired to provide a flux-coated ball wherein a calculated average roughness Ra (hereinafter, also referred to as surface roughness Ra) of the flux layer is 10 μm or less.

According to another aspect of the present invention, there is provided with a method of manufacturing a flux-coated ball including the steps of applying liquid flux containing a volatile solvent which is a single or mixed solvent selected from the group of ethyl acetate, acetone and methyl ethyl ketone to a surface of a ball-like joining material and drying the liquid flux applied to the surface of the joining material to form the flux-coated ball wherein thickness of the flux layer is within a range between 2.5 μm or more and 50 μm or less and a diameter of the flux-coated ball is 600 μm or less, and sphericity of the flux-coated ball is 0.9 or more.

Other objects and attainments of the present invention will be become apparent to those skilled in the art upon a reading of the following detailed description when taken in conjunction with the drawing.

### BRIEF DESCRIPTION OF THE DRAWING

FIG. 1 is a diagram for showing a configuration example of a flux-coated ball according to an embodiment of the invention.

### BEST MODE FOR CARRYING OUT THE INVENTION

The following will describe preferred embodiments of this invention more in detail with reference to the drawing. In this description, units (such as ppm, ppb and %) relating to composition of the flux-coated ball represent ratios to mass of the flux-coated ball (mass ppm, mass ppb and mass %) unless otherwise specified.

(1) Flux-Coated Ball 10:

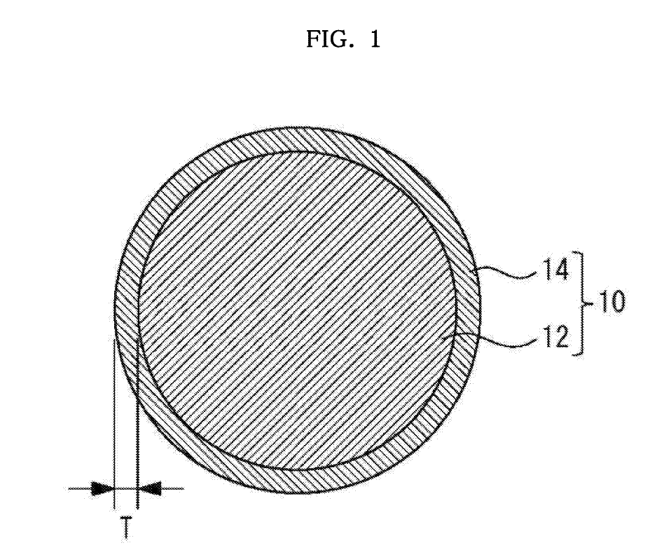

FIG. 1 shows a configuration example of a flux-coated ball 10 according to an embodiment of the invention. As shown in FIG. 1, the flux-coated ball 10 contains a joining material 12 and a flux layer 14 that covers a surface of the joining material 12. The flux-coated ball has a diameter of 600 μm or less, and sphericity of 0.9 or more.

Diameter of Flux-Coated Ball 10:

The diameter of the flux-coated ball is 1 through 600 μm. Setting the diameter of the flux-coated ball to be within a range of 1 through 600 μm allows any requirement for miniaturization of a printed circuit board and/or narrow pitch of electrode of the electronic component to be met. This also allows the electronic component to be downsized or highly integrated.

Surface Roughness Ra of Flux-Coated Ball 10:

Surface roughness Ra of the flux-coated ball 10 is 10 μm or less. In this embodiment, by using a high volatile flux solvent containing ethyl acetate, acetone or methyl ethyl ketone or a combination of them, the flux layer 14 is formed on a surface of the joining material 12. This prevents crystal grains from growing in the flux layer 14 during a step of forming the flux layer 14, so that the small crystal grains are made. Accordingly, roughness on the surface of the flux layer 14 decreases thereby, so that the surface roughness Ra of the flux layer 14 becomes smaller.

Sphericity of Flux-Coated Ball 10:

Sphericity of the flux-coated ball 10 is 0.9 or more. In this embodiment, as described above, using a high volatile solvent as flux solvent prevents the crystal grains from growing in the flux layer 14, so that the surface roughness Ra of the flux layer 14 becomes smaller. This enables the sphericity of the flux-coated ball 10 to be 0.9 or more. By enabling the sphericity of the flux-coated ball 10 to be 0.9 or more, heights of solder bumps are made even, which inhibits any bonding failure from occurring.

Since the coat of the flux layer 14 to the joining material 12 is performed by a step which is different from a common step of coating a flux layer to a solder ball, flux may be applied thereto so as to be partially thicker, so that the sphericity thereof may decrease. In general, since the larger the diameter of the ball has, a diameter of crystal in the surface or coated layer thereof is relatively made smaller, correlation between the diameter of the ball and the sphericity thereof becomes lower. For example, when the diameter of a Sn-based solder ball exceeds 600 μm, its sphericity can meet a standard sphericity of 0.9 or more with disregard for a diameter of crystal on the surface of the solder ball. However, the flux-coated ball 10 having a diameter similar to that of the solder ball may not meet any standard sphericity of 0.9 or more by any characteristic of flux. Therefore, according to this embodiment, as described above, an applicability of the diameter of the flux-coated ball 10 expands up to 600 μm, which copes with any characteristic intrinsic to the flux.

In the invention, the sphericity represents a gap from a true sphere. The sphericity can be determined by various kinds of methods, for example, a least squares center method (LSC method), a minimum zone center method (MZC method), a maximum inscribed center method (MIC method), a minimum circumscribed center method (MCC method), etc. For details, the sphericity is an arithmetic mean value calculated by dividing a diameter of each of 500 joining materials 12 by a length of the longest axis of each joining material. It is shown that when a value thereof is closer to the upper limit 1.00, this is closer to the true sphere. In this invention, the length of the diameter and the length of the longest axis are referred to as lengths measured by measuring equipment, ultra-quick vision, ULTRA QV 350-PRO manufactured by Mitsutoyo Corporation.

(2) Joining Material 12:

The joining material 12 is a ball-like joining material for joining an electrode of the semiconductor package to an electrode of the printed circuit board electrically.

Composition of Joining Material 12:

The joining material 12 is a metallic ball containing a metal itself, a metal compound, an alloy, a metal oxide or a mixed metal oxide. As the composition of the metallic ball, for example, Sn or solder alloy whose main component is Sn is exemplified. In a case where its main component is Sn, Sn content is 40 mass % or more. As the solder alloy, for example, Sn—Ag alloy, Sn—Cu alloy, Sn—Ag—Cu alloy, Sn—In alloy, Sn—Pb alloy, Sn—Bi alloy, Sn—Bi—Ag—Cu ally and the like are exemplified. A predetermined amount of alloy elements can be added to the solder alloy. As the alloy elements, for example, Ag, Cu, In, Ni, Co, Sb, Ge, P, Fe and the like are exemplified.

Further, when the metallic ball is composed of metal itself, the metal of one species selected from the group of Cu, Ni, Ag, Bi, Pb, Al, Sn, Fe, Zn, In, Ge, Sb, Co, Mn, Au, Si, Pt, Cr, La, Mo, Nb, Pd, Ti, Zr and Mg can be used. The joining material 12 may be composed of resin material, not metallic material. As the resin material, for example, amino resin, acrylic resin, ethylene vinyl acetate copolymer resin, styrene butadiene block copolymer, polyester resin, melamine resin, phenol resin, alkyd resin, polyimide resin, urethane resin, epoxy resin, crosslinked resin and the like are exemplified. Above all, it is preferred to use electroconductive plastic such as polyacetylene, polypyrrole, polythiophene, and polyaniline or the like.

The joining material 12 may be composed of a core ball in which a ball-like core material composed of a metal itself, a metal compound, an alloy, a metal oxide, a mixed metal oxide or resin is plated by any metal other than them. As the core ball, for example, a Cu core ball in which Ni plates a surface of a Cu ball as a barrier layer for preventing diffusion and a Sn—Ag—Cu alloy plates a surface of the Ni-plating layer is exemplified.

Diameter of Joining Material 12:

A diameter of the joining material 12 is 1 through 595 μm. Setting the diameter of the joining material 12 to be within a range of 1 through 595 μm allows any requirement for miniaturization of a printed circuit board and/or narrow pitch of electrode of the electronic component to be met. This also allows the electronic component to be downsized or highly integrated.

(3) Flux Layer 14:

The flux layer 14 is a material for removing a metallic oxide film on a surface of the joining material 12 and a metallic oxide film on a surface of the electrode in a reflow step to enhance wettability between the joining material 12 and the electrode.

Composition of Flux Layer 14:

The flux layer 14 contains a volatile solvent. As the volatile solvent, a high volatile solvent such as ethyl acetate, acetone or methyl ethyl ketone (hereinafter, also referred to as “MEK”), or a combination thereof are exemplified. In this invention, the volatile solvent almost evaporates during drying step to form the flux layer 14, but a part of the solvent remains in the flux layer 14. Accordingly, constituent parts of the flux solvent can be detected from the manufactured flux-coated ball 10.

The flux layer 14 is composed of one or plural species of constituent parts including compounds acting as an activator for preventing a metallic surface of solder ball or the like from being oxidized and removing the metallic oxide film during soldering. For example, the flux layer 14 may be composed of plural components including compounds acting as the activator, compounds acting as auxiliary activator and the like.

As the activator constituting the flux layer 14, anyone of an amine, an organic acid and a halogen, a combination of a plurality of amines, a combination of a plurality of organic acids, a combination of a plurality of halogens, a combination of a single amine, a single organic acid and a single halogen or a combination of plural amines, organic acids and halogens may be used depending on the property required in the present invention.

As the auxiliary activator constituting the flux layer 14, any one of an ester, an amide, an amino acid, a combination of a plurality of esters, a combination of a plurality of amides, a combination of a plurality of amino acids, a combination of a single ester, a single amide and a single amino acid or a combination of plural esters, amides and amino acids may be used depending on the property of an activator.

In addition, the flux layer 14 may contain rosin or resin, in order to protect compound and the like acting as the activator from the heat at the time of reflow treatment. In addition, the flux layer 14 may contain resin to bind compound and the like acting as the activator to the solder layer.

The flux layer 14 maybe composed of a single layer containing a single compound or plural compounds. In addition, the flux layer 14 maybe composed of plural layers containing plural compounds. The components constituting the flux layer 14 adhere to the surface of the solder layer in a solid state thereof, however, the flux needs to be liquefied or gasified in a step of binding the flux to the solder layer.

Therefore, the components constituting the flux layer 14 need to be soluble by the solvent for the coating with solution. However, in case of forming a salt, for example, any insoluble components exist in the solvent. The insoluble components exist in liquid flux, so that evenly adsorption thereof becomes difficult, in the flux containing low soluble components which cause forming sediment and the like. For this reason, the liquid flux cannot be composed by being mixed with a salt-forming compound in the prior art.

Whereas, in the flux-coated ball 10 having the flux layer 14 in the present invention, a flux multilayer may be formed by forming flux layers one by one and making them into a solid state thereof. Thus, even in a case that a salt-forming compound is used and the component cannot be mixed with the liquid flux, the flux layer 14 can be formed.

By coating the surface of the joining material 12, which is easy to oxidize, with the flux layer 14 acting as the activator, it is possible to inhibit oxidation of the surface of the joining material 12 during storage or the like.

The above-described flux-coated ball 10 according to the invention can be used in a solder joint which joins the electrode of the semiconductor package to the electrode of the printed circuit board.

Film thickness T of Flux Layer 14:

The film thickness T of the flux layer 14 is within a range of 2.5 through 50 μm at each side of the layer. Setting the film thickness T of the flux layer 14 to be 50 μm or less allows the prevention of aggregation of the flux-coated balls and the inhibition of a secondary particle formation by the flux-coated ball. Moreover, setting the film thickness T of the flux layer 14 to be 2.5 μm or more allows a constant amount of flux to be maintained so that it is possible to enhance the wettability of the solder when joining the solder to the electrode. In other words, when the flux layer 14 is thin (for example, the film thickness T of the flux layer 14 is less than 2.5 μm), the flux layer functions as only a protective material, not as flux, so that the wettability of the solder may deteriorate. In this embodiment, however, it is possible to surely maintain an amount of flux which is necessary for the wettability of the solder.

(4) Method of Manufacturing Flux-Coated Ball:

The following will describe an embodiment of a method of manufacturing the flux-coated ball 10 according to this invention. First, by an oil ball sphering method in which cut line solder is put into oil with a temperature more than a melting point of the solder and the solder can be made spherical by its surface tension, the joining material 12 having a diameter of 600 μm or less is produced.

Further, as another method therefor, there is an atomizing method in which molten solder material drops and the droplet is rapidly cooled to produce the spherical joining material 12.

A step of applying liquid flux containing a volatile solvent to a surface of the produced joining material 12 is then carried out. As the method of applying or coating the flux to the surface of the joining material 12, for example, a coating method using a pan coating apparatus is adaptable. In the pan coating method, after a drum receives the produced joining material 12, coating liquid (flux) is sprayed into the joining material 12 in the drum while the drum is rotated to coat the flux to the surface of the joining material 12. By drying the liquid flux applied onto the surface of the joining material 12, the flux layer 14 coating the surface of the joining layer 12 and having the film thickness of 50 μm or less is then formed. Thus, the flux-coated ball 10 having the diameter of 600 μm or less and sphericity of 0.9 or more is manufactured.

It is to be noted that as the coating method by the flux, any known coating method other than the above-described coating method using the pan coating apparatus is adaptable. For example, a coating method using a tumbling coating apparatus, a coating method using a fluidized coating apparatus, a coating method using a dipping coating apparatus or the like is adaptable.

### EXECUTED EXAMPLES

The following will describe executed examples of the invention, but the invention is not limited thereto. In these executed examples, solder balls and Cu core balls were prepared and flux was applied to a surface of each of these prepared solder balls and Cu core balls. Specifically, these prepared solder balls and Cu core balls were put into an inclined pan coating apparatus and rotated therein. In this state, the flux which had been produced by preparing 1 mass % of glutaric acid (as solute) using flux solution of the executed examples and the comparison examples, which would be described later, and filtering it was sprayed and coated onto a surface of each of these solder balls and Cu core balls. The spray then stopped and the rotation continued for ten minutes to dry so that the flux-coated balls each having a predetermined diameter were manufactured.

In executed examples 1 through 3, the flux layer, a film thickness of which was 10 μm of each side, was coated to a surface of each of the solder balls with a composition of each ball being Sn-3.0Ag-0.5Cu (hereinafter, also referred to as “SAC305”) and a diameter of each ball being 300 μm. Thus, the flux-coated balls each having a diameter of 320 μm were manufactured. In the executed example 1, glutaric acid was used as flux solute and high volatile ethyl acetate was used as flux solvent. In the executed example 2, glutaric acid was used as flux solute and high volatile methyl ethyl ketone was used as flux solvent. In the executed example 3, glutaric acid was used as flux solute and high volatile acetone was used as flux solvent.

In executed examples 4 through 6, the flux layer, a film thickness of which was 2.5 μm of each side, was coated to a surface of each of the solder balls with a composition of each ball being Sn-3.0Ag-0.5Cu and a diameter of each ball being 45 μm. Thus, the flux-coated balls each having a diameter of 50 μm were manufactured. In the executed example 4, glutaric acid was used as flux solute and high volatile ethyl acetate was used as flux solvent. In the executed example 5, glutaric acid was used as flux solute and high volatile methyl ethyl ketone was used as flux solvent. In the executed example 6, glutaric acid was used as flux solute and high volatile acetone was used as flux solvent.

In executed examples 7 through 9, the flux layer, a film thickness of which was 10 μm of each side, was coated to a surface of each of the solder balls with a composition of each ball being only Sn and a diameter of each ball being 50 μm. Thus, the flux-coated balls each having a diameter of 70 μm were manufactured. In the executed example 7, glutaric acid was used as flux solute and high volatile ethyl acetate was used as flux solvent. In the executed example 8, glutaric acid was used as flux solute and high volatile methyl ethyl ketone was used as flux solvent. In the executed example 9, glutaric acid was used as flux solute and high volatile acetone was used as flux solvent.

In executed examples 10 through 12, the flux layer, a film thickness of which was 10 μm of each side, was coated to a surface of each of the Cu core balls with a diameter of each ball being 50 μm. Thus, the flux-coated balls each having a diameter of 570 μm were manufactured. The solder layer constituting the Cu core ball had a composition of Sn-3.0Ag-0.5Cu. In the executed example 10, glutaric acid was used as flux solute and high volatile ethyl acetate was used as flux solvent. In the executed example 11, glutaric acid was used as flux solute and high volatile methyl ethyl ketone was used as flux solvent. In the executed example 12, glutaric acid was used as flux solute and high volatile acetone was used as flux solvent.

In comparison examples 1 through 6, the flux layer, a film thickness of which was 10 μm of each side, was coated to a surface of each of the solder balls with a composition of each ball being Sn-3.0Ag-0.5Cu and a diameter of each ball being 300 μm. Thus, the flux-coated balls each having a diameter of 320 μm were manufactured. In the comparison example 1, glutaric acid was used as flux solute and low volatile isopropyl alcohol (hereinafter, referred to as “IPA”) was used as flux solvent. In the comparison example 2, glutaric acid was used as flux solute and low volatile water was used as flux solvent. In the comparison example 3, glutaric acid was used as flux solute and low volatile methanol was used as flux solvent. In the comparison example 4, glutaric acid was used as flux solute and low volatile water and acetone were used as flux solvent. In the comparison example 5, glutaric acid was used as flux solute and low volatile water and IPA were used as flux solvent. In the comparison example 6, glutaric acid was used as flux solute and low volatile water and methanol were used as flux solvent.

In comparison examples 7 through 9, the flux layer, a film thickness of which was 0.5 μm of each side, was coated to a surface of each of the solder balls with a composition of each ball being Sn-3.0Ag-0.5Cu and a diameter of each ball being 300 μm. Thus, the flux-coated balls each having a diameter of 301 μm were manufactured. In the comparison example 7, glutaric acid was used as flux solute and high volatile ethyl acetate was used as flux solvent. In the comparison example 8, glutaric acid was used as flux solute and high volatile methyl ethyl ketone was used as flux solvent. In the comparison example 9, glutaric acid was used as flux solute and high volatile acetone was used as flux solvent.

In reference example, the flux layer, a film thickness of which was 10 μm of each side, was coated to a surface of the solder ball with a composition of the ball being only Sn and a diameter of the ball being 900 μm. Thus, the flux-coated ball having a diameter of 920 μm was manufactured. In the reference example, glutaric acid was used as flux solute and low volatile IPA was used as flux solvent.

The sphericity of each of the flux-coated balls manufactured in the executed examples 1 through 12, the comparison examples 1 through 9 and the reference example was measured. The sphericity of each flux-coated ball was measured by CNC image measurement system. Specifically, the equipment therefor was the ultra quick vision, ULTRA QV350-PRO manufactured by MITSUTOYO Corporation. In the above examples, the length of the diameter of each of the flux-coated balls and the length of the longest axis thereof were measured by measuring equipment and the sphericity was an arithmetic mean value calculated by dividing a diameter of each of 500 flux-coated balls by the length of the longest axis of each of 500 flux-coated balls. It is shown that when a value thereof is closer to the upper limit 1.00, this is closer to the true sphere.

The surface roughness Ra of each of the flux-coated balls manufactured in the executed examples 1 through 12, the comparison examples 1 through 9 and the reference example was measured. The surface roughness Ra was measured using a laser microscope VK-9510/corresponding to JIS B0601-1994) manufactured by KEYENCE. The surface roughness was measured within a specified range and a measurement pitch on z axis was set to be 0.1 μm. Under these conditions, the surface roughness about any optional 10 points of each ball was measured and their arithmetical mean was adapted as actual calculated average roughness Ra.

The flux weight ratio of each of the flux-coated balls manufactured in the executed examples 1 through 12, the comparison examples 1 through 9 and the reference example was measured. The flux weight ratio was calculated on the basis of the following expression (1).

Flux Weight Ratio=Flux Weight/Weight of Flux-coated Ball (1)

In the expression (1), unit was ppm. The flux weight of the expression (1) was calculated on the basis of the following expression (2).

Flux Weight=Weight of Flux-coated Ball-Weight of Washed Solder Ball (Washed Cu Core Ball) (2)

In the washing treatment of the expression (2), IPA was used and then, drying treatment was performed.

The wettability of each of the flux-coated balls manufactured in the executed examples 1 through 12, the comparison examples 1 through 9 and the reference example was measured. The wettability was decided so that the flux-coated balls were dispersed onto Cu plate and the Cu plate was heated for 30 seconds on a hot plate heated by 260 degree C. When a bonded interface occurs between the Cu plate and the solder part, the wettability was decided to be excellent (marked by O). When any ball does not bond the Cu plate and the ball was peels off the Cu plate by friction, the wettability was decided to be poor (marked by X).

Table 1 shows respective results of the sphericity, the surface roughness Ra, the flux weight ratio, and the wettability of each of the flux-coated balls manufactured in the executed examples 1 through 12, the comparison examples 1 through 9 and the reference example.

TABLE 1

| | | | | DIAM- | | | | | | | |
|---|---|---|---|---|---|---|---|---|---|---|---|
| | | | | ETER | DIAM- | | | | | | |
| | | | THICK- | OF | ETER | | | | | | |
| | | | NESS | JOIN- | OF | | | SURFACE | | | |
| | | | OF | ING | FLUX | | | ROUGH- | | FLUX | |
| | | | FLUX | MATE- | COAT | | | NESS | | WEIGHT | |
| | JOINING | SOLVENT | LAYER | RIAL | BALL | | | (Ra) | | RATIO | WETTA- |
| | MATERIAL | IN FLUX | μm | μm | μm | SPHERICITY | | μm | | ppm | BILITY |
| EXECUTED | SAC305 | ETHYL | 10 | 300 | 320 | ∘ | 0.98 | ∘ | 4.8 | 2 × 10⁴ | ∘ |
| EXAMPLE 1 | | ACETATE | | | | ≧0.9 | | ≦10 | | | |
| EXECUTED | SAC305 | MEK | 10 | 300 | 320 | ∘ | 0.98 | ∘ | 5.2 | 2 × 10⁴ | ∘ |
| EXAMPLE 2 | | | | | | ≧0.9 | | ≦10 | | | |
| EXECUTED | SAC305 | ACETONE | 10 | 300 | 320 | ∘ | 0.96 | ∘ | 4.5 | 2 × 10⁴ | ∘ |
| EXAMPLE 3 | | | | | | ≧0.9 | | ≦10 | | | |
| EXECUTED | SAC305 | ETHYL | 2.5 | 45 | 50 | ∘ | 0.97 | ∘ | 3.8 | 6 × 10⁴ | ∘ |
| EXAMPLE 4 | | ACETATE | | | | ≧0.9 | | ≦10 | | | |
| EXECUTED | SAC305 | MEK | 2.5 | 45 | 50 | ∘ | 0.95 | ∘ | 3.6 | 6 × 10⁴ | ∘ |
| EXAMPLE 5 | | | | | | ≧0.9 | | ≦10 | | | |
| EXECUTED | SAC305 | ACETONE | 2.5 | 45 | 50 | ∘ | 0.96 | ∘ | 3.8 | 7 × 10⁴ | ∘ |
| EXAMPLE 6 | | | | | | ≧0.9 | | ≦10 | | | |
| EXECUTED | CNCY Sn | ETHYL | 10 | 50 | 70 | ∘ | 0.93 | ∘ | 4.2 | 2 × 10⁵ | ∘ |
| EXAMPLE 7 | | ACETATE | | | | ≧0.9 | | ≦10 | | | |
| EXECUTED | CNCY Sn | MEK | 10 | 50 | 70 | ∘ | 0.91 | ∘ | 5 | 3 × 10⁵ | ∘ |
| EXAMPLE 8 | | | | | | ≧0.9 | | ≦10 | | | |
| EXECUTED | CNCY Sn | ACETONE | 10 | 50 | 70 | ∘ | 0.9 | ∘ | 4.8 | 3 × 10⁵ | ∘ |
| EXAMPLE 9 | | | | | | ≧0.9 | | ≦10 | | | |
| EXECUTED | Cu CORE BALL | ETHYL | 10 | 550 | 570 | ∘ | 0.97 | ∘ | 5.8 | 2 × 10⁴ | ∘ |
| EXAMPLE 10 | (SAC PLATING) | ACETATE | | | | ≧0.9 | | ≦10 | | | |
| EXECUTED | Cu CORE BALL | MEK | 10 | 550 | 570 | ∘ | 0.96 | ∘ | 5.1 | 2 × 10⁴ | ∘ |
| EXAMPLE 11 | (SAC PLATING) | | | | | ≧0.9 | | ≦10 | | | |
| EXECUTED | Cu CORE BALL | ACETONE | 10 | 550 | 570 | ∘ | 0.96 | ∘ | 6.1 | 2 × 10⁴ | ∘ |
| EXAMPLE 12 | (SAC PLATING) | | | | | ≧0.9 | | ≦10 | | | |
| COMPARISON | SAC305 | IPA | 10 | 300 | 320 | x | 0.06 | x | 11.2 | 2 × 10⁴ | ∘ |
| EXAMPLE 1 | | | | | | <0.9 | | >10 | | | |
| COMPARISON | SAC305 | WATER | 10 | 300 | 320 | x | 0.83 | x | 15.3 | 3 × 10⁴ | ∘ |
| EXAMPLE 2 | | | | | | <0.9 | | >10 | | | |
| COMPARISON | SAC305 | METHANOL | 10 | 300 | 320 | x | 0.88 | x | 13.7 | 2 × 10⁴ | ∘ |
| EXAMPLE 3 | | | | | | <0.9 | | >10 | | | |
| COMPARISON | SAC305 | WATER/ | 10 | 300 | 320 | x | 0.83 | x | 11.6 | 3 × 10⁴ | ∘ |
| EXAMPLE 4 | | ACETONE | | | | <0.9 | | >10 | | | |
| COMPARISON | SAC305 | WATER/ | 10 | 300 | 320 | x | 0.83 | x | 11.9 | 3 × 10⁴ | ∘ |
| EXAMPLE 5 | | IPA | | | | <0.9 | | >10 | | | |
| COMPARISON | SAC305 | WATER/ | 10 | 300 | 320 | x | 0.84 | x | 14.2 | 3 × 10⁴ | ∘ |
| EXAMPLE 6 | | METHANOL | | | | <0.9 | | >10 | | | |
| COMPARISON | SAC305 | ETHYL | LESS | 300 | 300- | ∘ | 0.99 | ∘ | 0.17 | LESS | x |
| EXAMPLE 7 | | ACETATE | THAN | | 301 | ≧0.9 | | ≦10 | | THAN | |
| | | ETC. | 0.5 μm | | | | | | | 1 × 10² | |
| | | | | | | | | | | ppm | |
| COMPARISON | SAC305 | MEK | LESS | 300 | 300- | ∘ | 0.99 | ∘ | 0.21 | LESS | x |
| EXAMPLE 8 | | | THAN | | 301 | ≧0.9 | | ≦10 | | THAN | |
| | | | 0.5 μm | | | | | | | 1 × 10² | |
| | | | | | | | | | | ppm | |
| COMPARISON | SAC305 | ACETONE | LESS | 300 | 300- | ∘ | 0.99 | ∘ | 0.37 | LESS | x |
| EXAMPLE 9 | | | THAN | | 301 | ≧0.9 | | ≦10 | | THAN | |
| | | | 0.5 μm | | | | | | | 1 × 10² | |
| | | | | | | | | | | ppm | |
| REFERENCE | CNCY Sn | IPA | 10 | 900 | 920 | ∘ | 0.95 | x | 18.7 | 1 × 10⁴ | ∘ |
| EXAMPLE | | | | | | ≧0.9 | | >10 | | | |

As shown in Table 1, since the executed examples 1 through 11 use the high volatile flux solvent in a step of forming the flux layer, growth of crystal grains is prevented in the flux layer and the surface roughness Ra of all the flux-coated balls exhibits 10 μm or less. As a result thereof, the sphericity of all the flux-coated balls exhibits 0.9 or more. Since the flux-coated balls manufactured in the executed examples 1 through 11 exhibit large flux weigh ratios and a suitable amount of flux can be maintained, their wettability exhibits excellent results.

Whereas, since the comparison examples 1 through 6 use the low volatile flux solvent in a step of forming the flux layer, growth of crystal grains is accelerated in the flux layer and the surface roughness Ra of all the flux-coated balls exhibits mare than 10 μm. As a result thereof, the sphericity of all the flux-coated balls indicates less than 0.9. Since the flux-coated balls manufactured in the comparison examples 1 through 6 exhibit large flux weigh ratios, their wettability exhibits excellent results.

On the other hand, since the comparison examples 7 through 9 use the high volatile flux solvent in a step of forming the flux layer, growth of crystal grains is prevented in the flux layer and the surface roughness Ra of all the flux-coated balls exhibits 10 μm or less. As a result thereof, the sphericity of all the flux-coated balls exhibits 0.9 or more. However, since the flux-coated balls manufactured in the comparison examples 7 through 9 exhibit small flux weigh ratios and a suitable amount of flux cannot be maintained, their wettability do not exhibit any excellent results.

From the above, when the flux solvent is low volatile solvent or the film thickness of the flux layer is thin, as shown in the flux-coated balls manufactured in the comparison examples 1 through 9, it has been confirmed that all of the sphericity, the surface roughness Ra and the wettability of the flux-coated ball cannot be satisfied. Whereas, according to the flux-coated balls manufactured in the executed examples 1 through 11, since the high volatile flux solvent is used even when a flux-coated ball having a small diameter is manufactured, it has been confirmed that all of the sphericity, the surface roughness Ra and the wettability of the flux-coated ball can be satisfied.

The terms and expressions which have been employed in the foregoing description are used therein as terms of description and not of limitation, and these are no intention, in the use of such terms and expressions, of excluding equivalent of the features shown and described or portions thereof, it being recognized that the scope of the invention is defined and limited only by the claims.

It is to be noted that any technical scope of the claims and/or meaning of term(s) claimed in the claims are not limited to the description in the above-mentioned embodiments. It should be understood by those skilled in the art that various modifications, combinations, sub-combinations and alterations may occur depending on design requirements and other factors insofar as they are within the scope of the appended claims or the equivalents thereof.

Although the single solvent selected from the group of ethyl acetate, acetone and methyl ethyl ketone has been described in each of the executed examples, this invention is not limited thereto. For example, the mixed solvent in which the ethyl acetate, the acetone and/or the methyl ethyl ketone are mixed can be used.

What is claimed is:

1. A flux-coated ball comprising:
a ball-like joining material; and
a flux layer that covers a surface of the joining material,
wherein the flux layer comprises a solvent which is a single or mixed solvent selected from a group of ethyl acetate, acetone and methyl ethyl ketone, and
wherein a thickness of the flux layer ranges from 2.5 μm to 50 μm and a diameter of the flux-coated ball is 600 μm or less, and a sphericity of the flux-coated ball is 0.9 or more.

2. The flux-coated ball according to claim 1, wherein the joining material comprises a metal, a metal compound, an alloy, a metal oxide or a mixed metal oxide.

3. The flux-coated ball according to claim 1, wherein an average roughness of the flux layer is 10 μm or less.

4. The flux-coated ball according to claim 2, wherein an average roughness of the flux layer is 10 μm or less.

5. A method of manufacturing a flux-coated ball comprising the steps of:
applying liquid flux comprising a volatile solvent which is a single or mixed solvent selected from a group of ethyl acetate, acetone and methyl ethyl ketone to a surface of a ball-like joining material; and
drying the liquid flux applied to the surface of the joining material to form the flux-coated ball wherein a thickness of the flux layer ranges from 2.5 μm to 50 μm and a diameter of the flux-coated ball is 600 μm or less, and a sphericity of the flux-coated ball is 0.9 or more.
